(19) United States
(12) Patent Application Publication
(10) Pub. No.: US 2006/0022066 A1
(43) Pub. Date: Feb. 2, 2006

(54) Aqua-Trellis

(76) Inventor: Gregory T. Jerstad, Rosemount, MN (US)

Correspondence Address: Roger L. Belfay, 829 Tuscarora Avenue, Saint Paul, MN, 55102, US

(21) Appl. No.: 10/903,369

(22) Filed: Jul. 30, 2004

(51) Int. Cl. B05B 15/06

(52) U.S. Cl. 239/276; 239/273; 239/279; 239/280; 239/450

(57) ABSTRACT

The Aqua-Trellis is a device for watering, feeding, and supporting plants comprising a plurality of vertical members with a plurality of supports for horizontal members and a plurality of horizontal members supported by said vertical member supports and provided with a plurality of ports for dispensing liquid on plants supported on said horizontal members. The Aqua-trellis optionally comprises a liquid supply system for the horizontal members and may include suitable pumps, reservoirs, and controls to adjust liquid flow throughout a network of horizontal and vertical members which combine to support, water, and feed a plurality of plants. The vertical members of the network are configured to support the horizontal members on smooth flat surfaces, like floors, for indoor use as well as on rough uneven surfaces for outdoor use.

The Aqua-Trellis is a device for watering, feeding, and supporting plants. The Aqua-Trellis comprises a plurality of vertical members with a plurality of supports for horizontal members, and a plurality of horizontal members supported by said vertical member supports and provided with a plurality of ports for dispensing liquid on plants supported on said horizontal members. The horizontal members may be of such strength and length as to require the support of more then two vertical members to permit the horizontal members to remain in a desired position without excessive bending, flexing or fracture.

Neither the horizontal nor the vertical members must be straight. Either the vertical members or the horizontal members, or both may be curved. Curved and straight vertical and horizontal members may be used in combination to achieve a desired effect or pattern.

### STATEMENT REGARDING FEDERAL SPONSORSHIP

No invention claimed in this application was made under Federally sponsored research or development.

### BACKGROUND OF INVENTION

Devices with a purpose similar to the Aqua-Trellis known at this time may be divided into two classes.

The first class includes a number of plant stands adapted for the feeding and support one or more plants on a single plant stand. Examples of devices in this class include U.S. Pat. Nos. 5,974,731 and 5,806,239 both to Wesolowski, U.S. Pat. No. 5,598,662 to Droste, U.S. Pat. No. 4,999,944 to Troy Et al., and U.S. Pat. No. 4,006,559 to Carlyon. In this class of devices a single stand with one or more plants is disclosed and each design is limited to a configuration of a single upright stand which is not extensible to a network of vertical and horizontal members.

The second class includes a number of plant feeding and support systems such as U.S. Pat. No. 4,922,653 to Stone. In this class the horizontal and vertical members of a network are combined to support plants and to provide storage for liquid which is dispensed below ground level to provide water and nutrients to the root systems of the supported plants. This class of devices does not provide for above ground watering or feeding of the plants supported thereon. The present invention is a network of vertical and horizontal members which serve to support a plurality of plants and to convey nutrients, liquids, insecticides, herbicides, or any other material soluble in the liquid, to the supported plants onto the surface of the plants or onto the surface of the ground or potted soil that contains the roots of the supported plants.

### BRIEF SUMMARY OF THE INVENTION

The Aqua-Trellis is a device for watering, feeding, and supporting plants comprising: 1) a plurality of vertical members each vertical member having a plurality of supports for horizontal members, and 2) a plurality of horizontal members supported by said vertical member supports and provided with a plurality of ports for dispensing liquid on plants supported on said horizontal members. Each vertical member is a post, of solid or hollow construction with clamps, braces, brackets, holes or other suitable means affixed to provide a supporting means for the horizontal members. A minimum of one vertical member is required to support the horizontal members, however the placement of the supporting holes or other support means on the vertical members may be arranged to permit three vertical members to support two sets of horizontal members. In addition the horizontal members may be of such strength and length as to require more then two vertical members to permit the horizontal members to remain in a desired position without excessive bending, flexing or fracture. In one embodiment the horizontal members are straight along their longest dimension. In others the horizontal members may be curved such as a semicircle, full circle, or any other curve which can be manufactured. In one embodiment the vertical members are straight along their greatest (vertical) dimension. In others the vertical members may be curved or irregularly shaped, so long as they remain upright when used in conjunction with the horizontal members. An advantage of this system is its modular nature. Any number of vertical and horizontal members may be used in combination to create a large variety of plant support networks ranging from the two vertical member and one horizontal member configuration to a large network of vertical and horizontal members covering many acres.

### BRIEF DESCRIPTION OF THE DRAWINGS

FIG. 1 is a side view of the Aqua-Trellis vertical member.

FIG. 2 is a front view of the Aqua-Trellis.

FIG. 3 is a top view of the Aqua-Trellis.

FIG. 4 is a top view of the Aqua-Trellis including selected liquid supply system components.

FIG. 5 is a plan view of an Aqua-Trellis network showing external support of horizontal members.

FIG. 6 is a plan view of an Aqua-Trellis network with three vertical members.

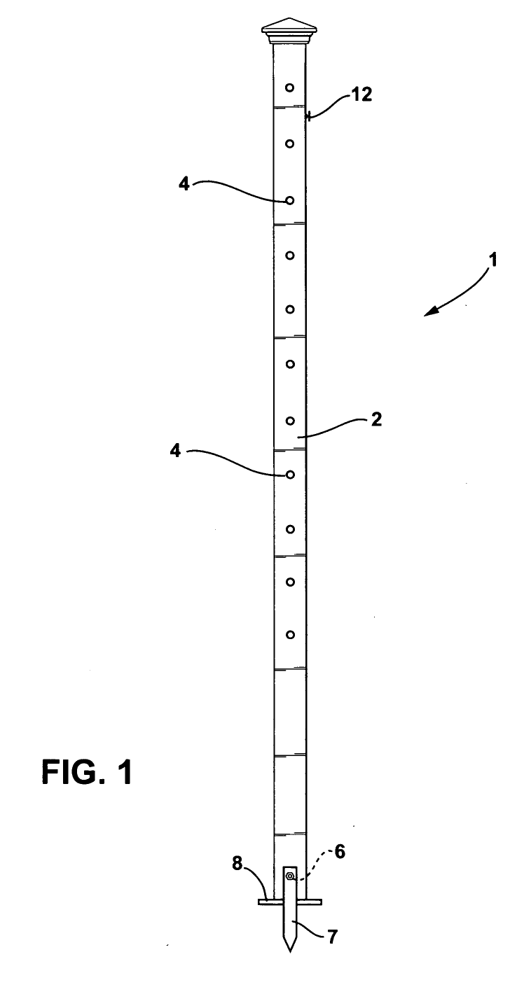

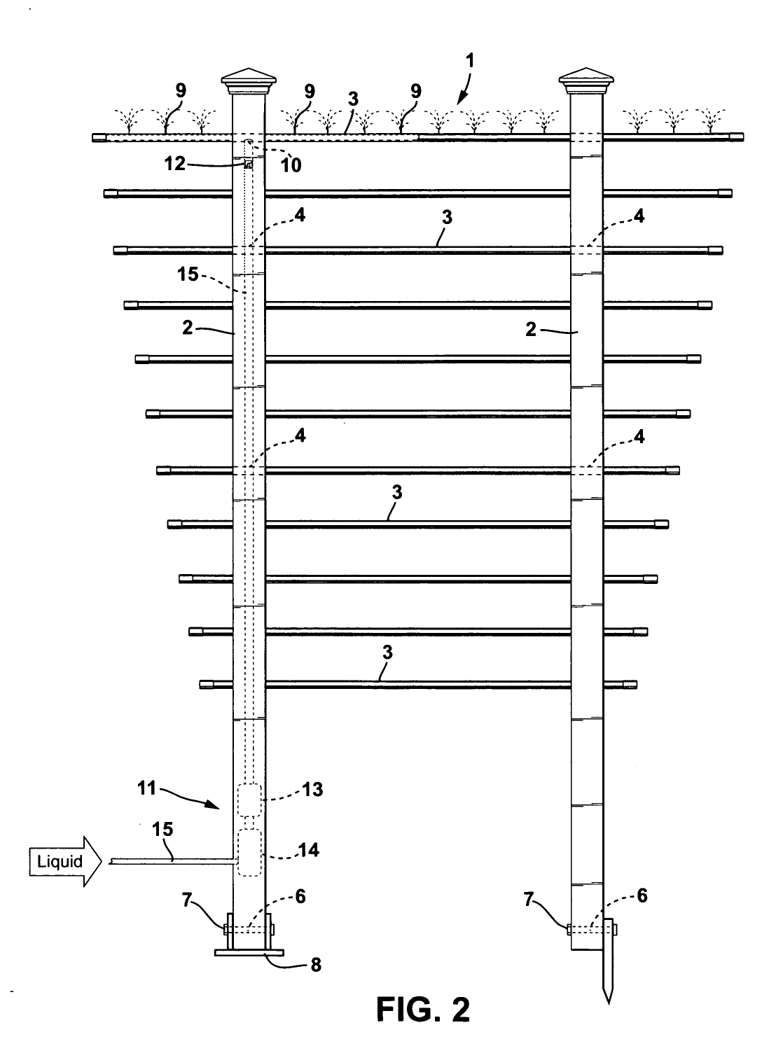

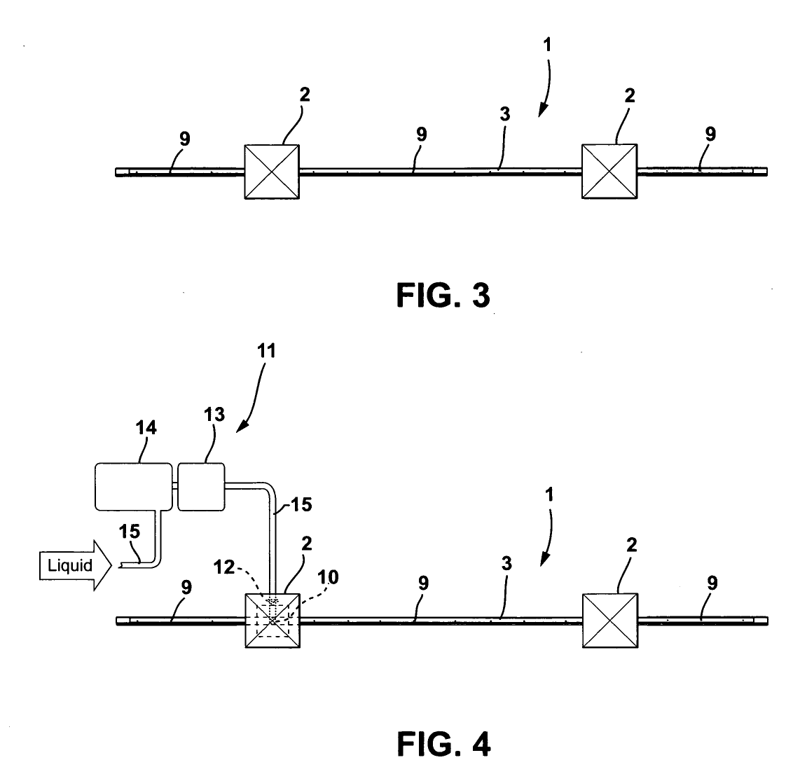

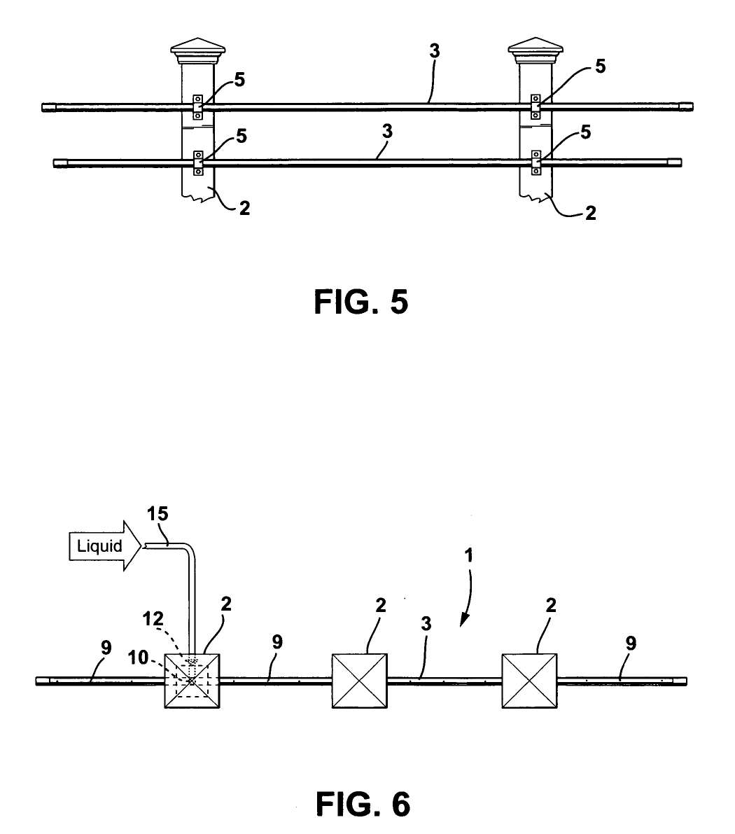

### DETAILED DESCRIPTION

The Aqua-Trellis 1 is a device for watering, feeding, and supporting plants comprising a plurality of vertical members 2 with a plurality of supports 9 for horizontal members 3, and a plurality of horizontal members 3 supported by said vertical member 2 supports 9 and provided with a plurality of ports 9 for dispensing liquid 15 on plants supported on said horizontal members 3. Each vertical member 2 is a post, of solid or hollow construction with clamps, braces, brackets affixed to provide a supporting means 4 for the horizontal members 3. The horizontal members 3 may be supported in holes in the vertical members 2. A minimum of one vertical member 2 is required to support 9 the horizontal members 3, However the placement of the supporting holes 4 or support 9 means on the vertical members 2 may be arranged to permit three vertical members 2 to support 9 two sets of horizontal members 3. In addition the horizontal members 3 may be of such strength and length as to require more then two vertical members 2 to permit the horizontal members 3 to remain in a desired position without excessive bending, flexing or fracture. In one embodiment the horizontal members 3 are straight along their longest dimension. In others the horizontal members 3 may be curved such as a semicircle, full circle, or any other curve which can be manufactured. In one embodiment the vertical members 2 are straight along their vertical dimension. In others the vertical members 2 may be curved or irregularly shaped, so long as they remain upright when used in conjunction with the horizontal members 3.

Vertical members 2 may be configured to include a lower hole 6 or attachment means 7 for a spike used to hold the vertical member 2 upright in soft soil or a bolt or similar device affixed to a floor for the same purpose. The vertical member 2 may also be provided with a flat base 8 for use on firm nearly level floors or similar surfaces.

The horizontal members 3 contain ports 9 for the dispensing of liquids 15 to the plants, their pots, or the ground where plant roots will benefit from the liquid 15 and the substances dissolved therein. These ports 9 may be configured to provide the liquids 15 at a slow rate to provide a dripping of liquid 15 or they may be configured to provide a spray or mist. Ports 9 may be fitted with nozzles to more finely control the rate and direction of the liquid 15 applied. Horizontal members 3 may include any combination of drip, nozzle, and spray configurations as the application or manufacturer may determine. The horizontal members 3 include a supply port 10 through which liquid 15 may enter the horizontal member 3 for distribution to the remaining ports 9. When used in conjunction with a liquid 15 distribution system 11 this supply port 10 may be attached to a supply tube either directly or through a valve mechanism 12 which controls the rate at which liquid 15 enters the horizontal member 3 and therefore the rate at which liquid 15 is applied by the ports 9.

In some embodiments the vertical members 2 includes a liquid 15 supply system 11 attached to the outside of the vertical members 2. The liquid 15 supply system provides liquid 15 to the supply port 10 of the horizontal members 3 either by direct attachment to said supply port 10 or through a valve mechanism 12 attached to said supply port 10 as described above.

In some embodiments the vertical members 2 includes a liquid 15 supply system attached to the inside of the vertical members 2. The liquid 15 supply system provides liquid 15 to the supply port 10 of the horizontal members 3 either by direct attachment to said supply port 10 or through a valve attached to said supply port 10 as described above.

It will be appreciated that the liquid 15 distribution system 11 may include any number of flow control valves and supply tubes configured to control and direct the flow of liquid 15 to the horizontal members 3, as well as a pump 13 to provide pressure to effect the liquid 15 distribution, although where the liquid 15 is available under pressure, such as from a municipal water supply outlet, a pump may not be required. It will also be appreciated that some of the horizontal members 3 may not be supplied by the liquid 15 distribution system 11. The liquid 15 distribution system 11 may also include a reservoir 14 for the storage of liquid 15 before it is recycled to the liquid 15 distribution system 11 or to permit solid insecticides, herbicides, or fertilizers to dissolve before application. Any or all parts of the liquid 15 supply system may include automated controls.

Feeding of plants means the provision of nutrients in liquid 15 form or provision of solid material dissolved in a suitable liquid. Support 9 of a plant means holding it in a desired position by any suitable means, such as tying the plant to the horizontal member 3 with string twine or wire, hanging the plant's pot or saucer from the horizontal member 3 by any suitable means. Plants may also be supported by the vertical member.

I claim:

1) A device for watering, feeding, and supporting plants comprising:
a) a plurality of vertical members with a plurality of supports for horizontal members;
b) a plurality of horizontal members supported by said vertical member supports and provided with a plurality of ports for dispensing liquid on plants supported on said horizontal members.

2) The device of claim 1 further comprising a liquid supply system for the horizontal members and attached to one or more of the vertical support members to provide liquid to one or more of the horizontal support members.

3) The device of claim 2 wherein the liquid supply system for the horizontal members is enclosed within the vertical member.

4) The device of claim 2 wherein the liquid supply system for the horizontal members is externally attached to the vertical members.

5) The device of claim 2 further comprising a plurality of valve mechanisms to control the flow of liquid from the liquid supply system to one or more horizontal members.

6) The device of claim 2 further comprising a pump to provide pressure to effect the distribution of liquid to the horizontal members.

7) The device of claim 2 further including a reservoir for holding a supply of liquid.

8) The device of claim 2 further comprising a plurality of automated controls to regulate the supply of liquid to the horizontal members.

9) The device of claim 1 wherein the ports in one or more of the horizontal members allow said liquid to drip onto a plurality of plants supported by the horizontal member.

10) The device of claim 1 wherein the ports in one or more of the horizontal members further comprise nozzles to direct and regulate the flow of said liquid onto plants supported by the horizontal members.

11) The device of claim 1 wherein one or more of the vertical members further comprises a hole for a spike to hold the vertical member upright on a uneven surface.

12) The device of claim 1 wherein one or more of the vertical member further comprises a base to hold the vertical member upright on a flat surface.
